(19) United States
(12) Patent Application Publication
(10) Pub. No.: US 2017/0282075 A1
(43) Pub. Date: Oct. 5, 2017

(54) METHODS, SYSTEM AND NODES FOR HANDLING MEDIA STREAMS RELATING TO AN ONLINE GAME

(71) Applicant: TELEFONAKTIEBOLAGET LM ERICSSON (PUBL), Stockholm (SE)

(72) Inventors: Julien MICHOT, Sundyberg (SE); Jouni MÄENPÄÄ, Nummela (FI)

(73) Assignee: TELEFONAKTIEBOLAGET LM ERICSSON (PUBL), Stockholm (SE)

(21) Appl. No.: 15/513,817

(22) PCT Filed: Sep. 24, 2014
(86) PCT No.: PCT/SE2014/051095

§ 371 Date: Mar. 23, 2017

(51) Int. Cl. A63F 13/5258; A63F 13/497; A63F 13/86; H04L 29/06; H04N 21/478

(52) U.S. Cl. CPC A63F 13/5258; H04L 65/60; H04L 65/4076; H04N 21/4781; A63F 13/86; A63F 13/497; A63F 2300/6661

(57) ABSTRACT

The present disclosure relates to a method (40) performed in a system (10) for handling a media stream relating to an online game provided by a game cloud system (20). The system (10) comprises at least one node (11, 12). The method (40) comprises transmitting (41), to the game cloud system (20), a message comprising data relating to at least one virtual camera, and receiving (42), from the game cloud system (20), at least one first media stream relating to the online game as captured by the at least one virtual camera. The disclosure also relates to a corresponding system, computer programs and computer program products, and also to method in a game engine and a game engine.

### TECHNICAL FIELD

The technology disclosed herein relates generally to the field of online gaming, and in particular to handling of media streams relating to such online gaming.

### BACKGROUND

“Cloud gaming” (also denoted gaming on demand and on-line gaming) is an umbrella term used to describe a form of online game distribution aimed at providing end users with frictionless and direct playability of games using various devices. Currently there are two main types of cloud gaming: cloud gaming based on video streaming and cloud gaming based on file streaming.

Cloud gaming based on video streaming is a game service which takes advantage of a broadband connection, large server clusters, encryption and compression in order to stream game content to a user's device. This allows direct and on-demand streaming of games onto computers, consoles and mobile devices, similar to video on demand, through the use of a thin client. Users can thereby play games without downloading or installing the actual game. The actual game is instead stored on an operator's or game company's server and is streamed directly to e.g. computers accessing the server through the thin client. The actions from the user (player), i.e. inputs such as pressing of controls and buttons are transmitted directly to the server, where they are recorded, and the server then sends back the game's response to the player's input.

Game content is not stored on the subscriber's hard drive and game code execution occurs primarily at the server cluster. The subscriber can thereby use a less powerful computer to play the game than the game would normally require, since the server cluster does all performance-intensive operations. Letting the servers perform the required processing, which has conventionally been done by the end user's computer, makes the capabilities of the user devices unimportant to a large extent.

Cloud gaming based on file streaming, also known as progressive downloading, deploys a thin client in which the actual game is run on the user's gaming device such as for instance a mobile device, a personal computer (PC) or a console. A small part of a game, usually less than 5% of the total game size, is downloaded initially so that the player can start playing quickly. The remaining game content is downloaded to the end user's device while playing. This allows instant access to games with low bandwidth Internet connections without lag. The cloud is used for providing a scalable way of streaming the game content and processing intensive data analysis.

Cloud gaming based on file streaming requires a user device that has the hardware capabilities to operate the game. Downloaded game content is often stored on the end user's device where it is cached.

Video game broadcasting allows players to record and stream and/or broadcast their game play. There are video game broadcasting services, wherein people broadcast themselves playing and/or talking about games while other people, viewers, watch them and at the same time chat about it, or watch “highlights”, which are typically parts of the recorded videos. Such services are becoming increasingly popular.

### SUMMARY

What is broadcasted in today's live game streaming services is only what the player sees, and this may not be the best viewing angle, the best location, etc. for understanding or appreciating the whole game status. Further, the player typically controls the video quality and format, which thus might not give optimal rendering, audio and/or video quality. This may further reduce the viewer's experience. It would be desirable to improve on the viewer's experience.

An object of the present disclosure is to solve or at least alleviate at least one of the above mentioned problems.

The object is according to a first aspect achieved by a method performed in a system for handling a media stream relating to an online game provided by a game cloud system. The system comprises at least one node. The method comprises transmitting, to the game cloud system, a message comprising data relating to at least one virtual camera, and receiving, from the game cloud system, at least one first media stream relating to the online game as captured by the at least one virtual camera.

The method enables improvements on the viewer's experience and enables making broadcasts of gaming events easier to follow. This is brought about by the method by enabling the selection of e.g. the viewing directions and locations. Such selection can be made by sending data defining this, the data relating to a virtual camera. The method provides a producer of a game broadcast with means to control virtual cameras, to add events, to modify graphics, etc. The gaming events may thereby be rendered more engaging. Still further, the method enables the provision of a better view, a replay/slow motion with different camera angles etc. whereby an improved understanding of the whole game progress and thus improved viewer experience is provided.

The object is according to a second aspect achieved by a system for handling a media stream relating to an online game provided by a game cloud system. The system comprising at least one node and is configured to transmit, to the game cloud system, a message comprising data relating to at least one virtual camera, and receive, from the game cloud system, at least one first media stream relating to the online game as captured by the at least one virtual camera.

The object is according to a third aspect achieved by a computer program for a system for handling a media stream relating to an online game provided by a game cloud system. The computer program comprises computer program code, which, when executed on at least one processor of the system causes the system to perform the method as above.

The object is according to a fourth aspect achieved by a computer program product comprising a computer program as above and a computer readable means on which the computer program is stored.

The object is according to a fifth aspect achieved by a method performed in a game engine for providing a media stream relating to an online game. The method comprises receiving, from a node, a message comprising data relating to at least one virtual camera; providing at least one virtual camera based on the received data; rendering at least one first media stream relating to the online game as captured by the at least one virtual camera; and transmitting the at least one first media stream to the node.

The object is according to a sixth aspect achieved by a game engine for providing a media stream relating to an online game. The game engine is configured to receive, from a node, a message comprising data relating to at least one virtual camera; provide at least one virtual camera based on the received data; render at least one first media stream relating to the online game as captured by the at least one virtual camera; and transmit the at least one first media stream to the node.

The object is according to an eight aspect achieved by a computer program for a game engine for providing a media stream relating to an online game, the computer program comprising computer program code, which, when executed on at least one processor on the game engine causes game engine to perform the method as above.

The object is according to a ninth aspect achieved by a computer program product comprising a computer program as above and a computer readable means on which the computer program is stored.

Further features and advantages of the present disclosure will become clear upon reading the following description and the accompanying drawings.

### BRIEF DESCRIPTION OF THE DRAWINGS

FIG. 1 illustrates schematically an environment in which embodiments of the present disclosure may be implemented.

FIG. 2 illustrates a feature enabled according to an aspect of the present disclosure.

FIG. 3 is a sequence diagram illustrating aspects of a providing a gaming event for broadcasting.

FIG. 4 illustrates a flow chart over steps of a method in a system in accordance with the present disclosure.

FIG. 5 illustrates schematically a system and means for implementing embodiments of the present disclosure.

FIG. 6 is a flow chart over steps of a method in a game engine in accordance with the present disclosure.

FIG. 7 illustrates schematically a game engine for implementing embodiments of the present disclosure.

### DETAILED DESCRIPTION

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

It is foreseen that video game broadcasting will change and will be more and more like a show, event or movie production, in the sense that players of a game will mostly be both “actors” and other people or entities will have work similar to todays' cameramen. In order to increase a viewer's experience, a production team (virtual or real) comprising a film director, cameramen etc. are, according to an aspect of the present disclosure, enabled to create an original content out of the players' streams, commentators' videos etc. and are also enabled to create new gameplay videos.

As mentioned earlier, today, the viewer might not have the best “location” in a virtual game arena of the on-going game. The viewer might be able to understand more of the game if given a better viewing point. The viewer might also miss important moments of the game. These drawbacks, among others, are in various aspects of the present disclosure eliminated or at least mitigated by providing means to improve on the viewer experience.

A simple example of the above described shortcomings of prior art is a character of the game entering an empty room. The player may broadcast what is rendered on his screen and what is typically seen by the character of the game would (for first-person games) be the empty room. However, a nicer visualization (for the viewer) might be to see the character enter the room. Such visualization may, according to the present teachings, be given by placing a virtual camera in the room, on the floor, pointing towards the character entering the room. Even more, imagine the sun strongly shining behind the character; the viewer will only see the characters' outline due to the backlight. This view might not be very nice for a player but would be for someone who watches the game.

In various aspects, the present disclosure gives the freedom to someone, e.g. a “film director”, and the ability to select a different viewpoint, and also other options, of the gameplay by defining a number of controls channels between different elements of a cloud system for gaming events. Such “film director” may be a virtual “film director” in the form of computer programs and/or devices, or a real film director.

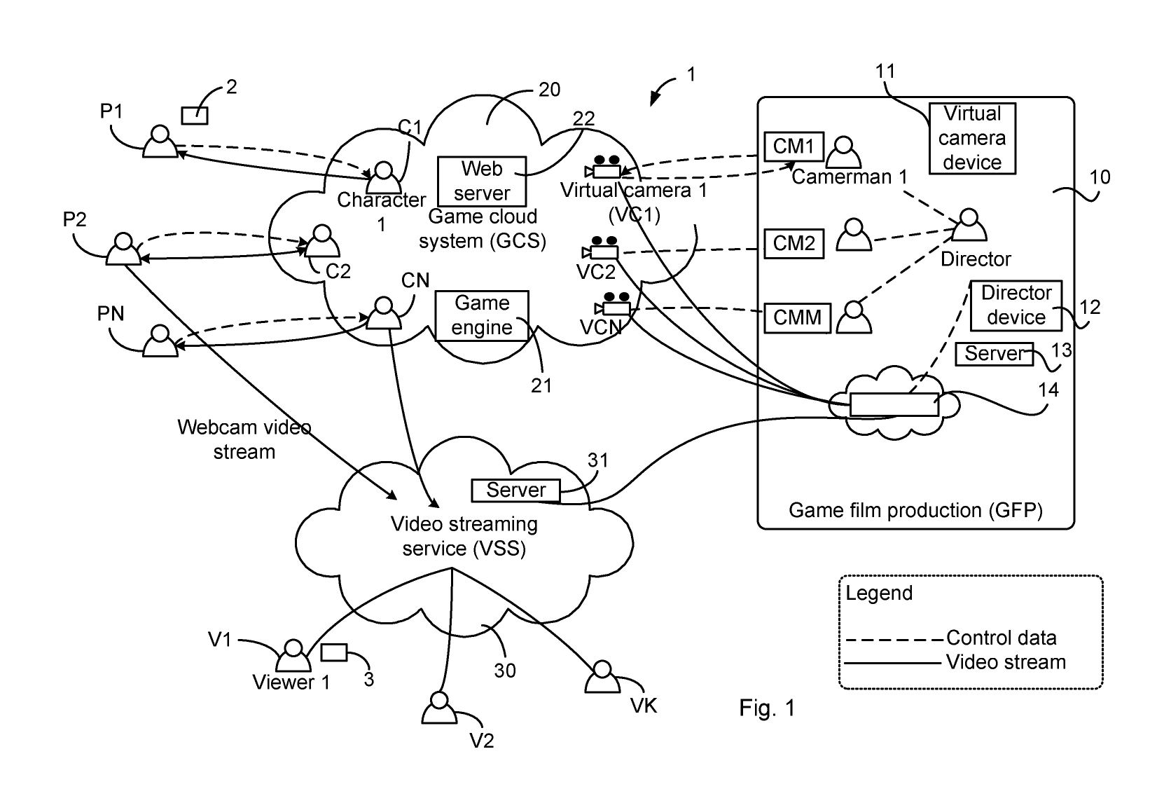

FIG. 1 illustrates schematically an environment in which embodiments of the present disclosure may be implemented. In particular, an architecture, control channels, and media channels according to an aspect of the present disclosure are illustrated. A cloud-based control system 1 for gaming events comprises a game film production (GFP) system 10, a game cloud system (GCS) 20 and a video streaming service 30. The cloud-based control system 1 may comprise virtual cameras in gaming event broadcasting, wherein the virtual cameras can be controlled by cameramen, which are real or virtual. A “virtual cameraman” can, as the “film director” be implemented by means of computer programs and/or devices.

A number of players, a first player P1, a second player P2, . . . , and an n:th player PN are illustrated as participating in an on-going game provided by the GCS 20. Each player P1, P2, . . . , PN may control (“be”) a respective character C1, C2, . . . , CN in the game. Each character has an associated virtual camera that is partly controlled by the player, in that the game play is rendered based on the players' input. The character, sometimes also referred to as avatar, may be seen as a virtual actor e.g. in a three-dimensional game world that is controlled by the player. For such control, the player P1, P2, . . . , PN inputs commands, e.g. by using an input device, such as for instance moving a joystick, pressing buttons etc. The commands are conveyed in a control data stream to a game engine 21 of the GCS 20. The control data streams are indicated by dashed lines from each player P1, P2, . . . , PN to each respective character C1, C2, . . . , CN. The character C1 of a first player P1 may thereby be controlled and e.g. moved within a scenery of the game, performing various actions within the game. The control commands and actions from the player are sent to the game engine 21 or related server and may be recorded and stored in a memory.

The GCS 20 may comprise a game engine 21, which sends back the game's responses to the player's input, as indicated by a solid line from each character C1, C2, . . . , CN of the game to the respective player P1, P2, . . . , PN, which the players then again act upon. The control data streams between the game engine 21 and the players may for instance comprise meta data such as location, actions, etc. The GCS 20 may comprise e.g. one or more web servers 22 and any number of other servers and/or server clusters.

A player P1, P2, . . . , PN may record and stream and/or broadcast his game play. This rendering of a recording of the game play may be performed locally in a device 2 of the player or such recording may be received from the GCS 20. Although a user device 2 is illustrated only for the first player P1, each player has some type of device enabling the playing of the game. Such device 2 may for instance comprise a computer, a game console, a mobile communication device etc.

A media stream comprising e.g. audio and video related to the game play may be received by the player from the game engine 21, as indicated by a solid line from the character C1 to the first player P1. It is noted that the characters are shown only for illustration purposes, and that it is the GCS 20 (e.g. the game engine 21 thereof) that receives/sends/creates media streams relating to the game that includes the characters.

The N:th player PN, for instance, may choose to send his media stream relating to the game forward from the game engine 21 to the Video streaming service 30, as indicated by solid line from character N to the Video streaming Service 30, e.g. to a video streaming server 31 thereof. The players P1, P2, . . . , PN can send video and audio streams from both within the game and also from external cameras (webcams) and microphones. For instance, the second player P2 may use a web camera to film himself when playing, and send a web camera video stream to the video streaming service 30, as indicated by solid line from the second player P2 to the video streaming service 30.

The players P1, P2, . . . , PN may receive a respective one or more media stream(s) (e.g. video streams as indicated in the figure) from the GCS 20, e.g. the game engine 21 thereof, if the rendering is not done locally, as is for instance done in cloud gaming.

The GCS 20 may comprise a number of servers for providing the game. In one embodiment, the GCS 20 comprises simply a game engine 21, for instance a game engine server. One game engine 21 is illustrated in the figure, but it is realized that the GCS 20 may comprise any number of processing devices, e.g. servers, and also memory devices for storing data relating to the players P1, P2, . . . , PN, for instance a cluster of game engine servers. In this context it is noted that a game engine comprises a software framework enabling creation and development of for instance video games. The game engine 21 may comprise a rendering engine for rendering 2-dimensional (2D) or 3-dimensional (3D) graphics, the game engine 21 may be used for handling sound, scripting, streaming, memory management etc. The term “game engine” is often interpreted as the software responsible for the game mechanics, and may be provided in a server, e.g. in the game engine 21. This is known within the art and will not be described in further detail.

The GCS 20 may receive and store all the players' data and (eventually) render and stream the game for some devices. An example of such streaming is illustrated in FIG. 1 for the N:th player by the solid line from the N:th players' character CN, to the video streaming service 30.

In an aspect of the present disclosure, the GCS 20 also renders virtual cameras VC1, VC2, VCN and streams them (i.e. streams media streams of views as rendered by the virtual cameras according to settings of them) to the GFP 10 and in particular to virtual camera devices CM1, CM2, . . . , CMM, 11 of the GFP 10.

The Video streaming service (VSS) 30 may comprise one or more processing devices, e.g. a video streaming server 31, as well as memory devices. The VSS 30 may receive media streams directly from the players and from the GCS 20. The VSS 30 may also perform some processing of the media streams, e.g. perform switching, mixing, and transcoding. The VSS 30 also comprises means for sending the media streams to a number of viewers V1, V2, . . . , VK.

The viewers V1, V2, . . . , VK have a user device 3, e.g. a computer, and may use it to select which video game stream to watch. The viewers V1, V2, . . . , VK may receive media stream(s) from the VSS 30. The viewers may, in an aspect, connect directly to the GCS 20, and receive game states and rendering options, such as pre-defined location from which to view the gaming event. A game state may be seen as the state of the game, e.g. defining properties of the game such as list of participating players, scores of the players, locations of characters etc., in essence keeping track of all properties that change during the gameplay.

In an aspect of the present disclosure, the viewers V1, V2, . . . , VK may interact with the GFP 10, for instance by voting about future developments in the game. They could for instance vote about virtual gifts (e.g. a new weapon) to be given to the players' characters C1, C2, . . . , CN in the game.

In an aspect of the present disclosure, the VSS 30 may also interact with the GFP 10, for instance by providing the GFP 10 (e.g. the director device 12 thereof) with statistics on streams that the VSS 30 sends to the viewers. The GFP 10 may utilize such information e.g. to decide on broadcasting in areas having may viewers.

It is noted that there is typically a much higher number of viewers V1, V2, . . . , VK than players P1, P2, . . . , PN, i.e. K>>N.

The GFP 10 may create one or more media streams and send them to the VSS 30, e.g. the video streaming server 31 thereof.

In an aspect, the GFP 10 comprises a film director device 12, which may be seen as a device implementing a virtual person (automated) performing tasks of a film director of a film production. The film director device 12 may be configured to receive input from a user (e.g. a film director) for editing media streams, or the film director device 12 may be automated to perform film director tasks such as editing etc. The film director device 12 may receive input streams from a user thereof and/or from the virtual camera devices CM1, CM2, . . . , CMM and/or from viewers V1, V2, . . . , VK and/or from any device of the GCS 20, e.g. the game engine 21. The film director device 12 may process the input streams in order to create desired output streams. Such processing may comprise selecting certain media streams, edit the selected media streams, switching, mixing, etc. It is again noted that the processing can be controlled by a user (e.g. a film director) or the processing can be configured and automated.

The GFP 10 may also comprise virtual camera devices CM1, CM2, . . . , CMM, 11 receiving media stream from the virtual cameras VC1, VC2, . . . , VCN. The number M of virtual camera devices may, but need not, be equal to the number N of virtual cameras. One virtual camera device 11 may be used for controlling one or more virtual cameras and receiving media streams from them.

The virtual camera device CM1, CM2, . . . , CMM, 11 may be seen as implementing functions corresponding to those of cameramen of a film production. The virtual camera devices CM1, CM2, . . . , CMM may thus be seen as virtual cameramen or as an input means for one or more persons (e.g. cameramen) producing a film based on a game event. The virtual camera devices 11, CM1, CM2, . . . , CMM may comprise a processing unit, e.g. a server. The virtual camera devices 11, CM1, CM2, . . . , CMM may comprise input means for receiving user input, e.g. defining a certain virtual camera to be requested or deleted. The virtual camera devices 11, CM1, CM2, . . . , CMM may also be configured to communicate with the director device 12, e.g. receive instructions therefrom. The virtual camera devices 11, CM1, CM2, . . . , CMM may thus be seen as automated cameramen receiving instructions from the director device 12, and/or receiving input from a user (e.g. a cameraman), that in turn receive orders from the film director. The virtual camera devices 11, CM1, CM2, . . . , CMM may control a number of virtual cameras provided in the GCS 20.

The GFP 10 may comprise yet additional processing means, for instance one or more servers 13 and devices such as switches (indicated at reference numeral 14). Such additional processing means may be configured to receive input from viewers V1, V2, . . . , VK, e.g. voting input as described earlier.

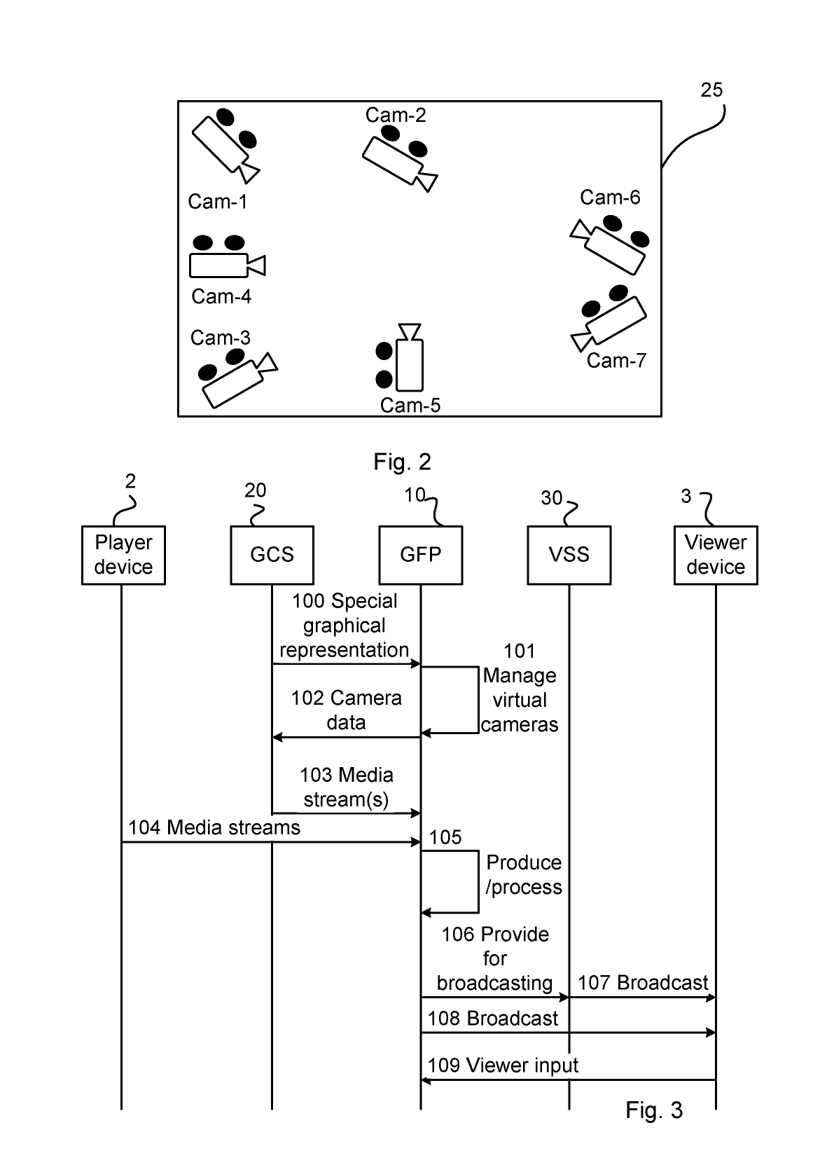

FIG. 2 illustrates a feature enabled according to an aspect of the present disclosure. The GFP 10 may receive, from the GCS 20, various types of special graphical representations of a game arena or game world of a game. Such special graphical representation, implemented e.g. through a web page, allows the director to easily see, select and control the virtual cameras of the GCS 20. FIG. 2 illustrates an example of how an interface 25 for controlling the virtual cameras may look like. The GFP 10 may e.g. receive a 2D map of the virtual cameras Cam-1, Cam-2, Cam-3, Cam-4, Cam-5, Cam-6, Cam-7 in a game, as illustrated in FIG. 2. Using the interface 25, the director can easily move the virtual cameras, select a camera so that it can be turned, tilted, zoomed, and so forth, change their direction, add new cameras, remove old cameras, click on a camera to see and modify its settings etc. This provides an easy and comprehensive way of controlling the virtual cameras.

The GFP 10, e.g. the director device 12 thereof, may perform tasks such as run replays, add graphics, modify graphics, and apply censorship. Further, the GFP 10 may receive a mosaic view of all the virtual camera signals received from the GCS 20. For instance, small views of all the respective virtual camera signals may be displayed on a screen at the same time. This facilitates a user to control of the virtual cameras.

For viewers V1, V2, . . . , VK that are following the gaming event by running a game engine locally or in the GCS 20, the GFP 10 can also control these viewers' game engines. An example is the ability of the GFP 10 to influence from which location the viewers are following the game (e.g., choose the location of a virtual auditorium).

In an aspect, the cameramen may be automated, and the game engine 21 may send media streams (e.g. video streams) from multiple different angles to the GFP 10, e.g. a director device 12 thereof, the videos being selected by the game engine 21. The user of the director device 12 (a director) may be provided with an interface and see a mosaic layout and may select which camera to broadcast to the viewers. The director may be enabled to add new virtual cameras dynamically and also control any single virtual camera by turning, tilting, and zooming it. The game engine 21 may generate a special view, e.g., rendered on a web page, that shows the locations of the virtual cameras on the game arena, allowing the director to for instance select and adjust any camera. In this context it is noted that the director may do such action e.g. by using an input device for inputting instructions to the director device 12. In other embodiments, the functions of the director are automated; the director may be seen as a pre-programmed virtual director.

In a movie production, it is up to the film director to select the camera angles, the camera locations, etc. and it is typically not up to the actors. In line with this, and according to an aspect of the present disclosure, the film director is allowed to orchestrate the ‘show’ by creating virtual cameras, running in the GCS 20, which can be controlled by cameramen controlling camera devices CM1, CM2, . . . , CMM according to the director's orders input via the director device 12.

The game engine 21 may keep a record of what has happened in the game during the past few minutes. This allows the director to replay an event that took place in the game even from an angle where there was no virtual camera originally. The director may also receive media streams from physical cameras such as web cameras of the players P1, P2, . . . , PN. The director may then add e.g. a real video of the face of the player displayed in a small window on the corner of the broadcasted video stream. Another webcam-related feature comprises the video streams from the player's web cameras to be used for recognizing the player's facial expressions. The facial expressions of the player may then be reflected on the character's face in the game. This feature allows the director to zoom to a character's face for instance during a replay. For implementing such feature, the GFP 10 may receive the respective player's video streams directly from the players (not illustrated in the FIG. 1). The director may then (by means of the director device 12) add and/or modify the graphics that the game engine 21 of the GCS 20 renders and sends to the GFP 10 by using the player's video streams. As a particular example, the director may modify a character's facial expressions for a replay to make the situation more dramatic. The director may also be able to censor some violent action if it is known that there are children viewing the gaming event. The director may also create a specific media stream intended for children, e.g. omitting certain action.

In the following some control channels provided by the present disclosure are described. One or more of the exemplifying control channels may be used in any combination for implementing various embodiments of the present disclosure.

The control channels may for instance take the form of:
A WebSocket connection between the user device 2 and a web server 22 running within the GCS 20. This option assumes that the user is using a web browser.
A Web Real-Time Communication (WebRTC) data channel connection. Also this option assumes that the user is using a web browser.
Bi-directional HyperText Transfer Protocol (HTTP) connection implemented for instance using HTTP long polling. Also this option assumes the user using a web browser.
A regular Transmission Control Protocol (TCP), User Datagram Protocol (UDP), or Stream Control Transmission Protocol (SCTP) connection. This alternative may typically be used by native applications, i.e. non-web-based applications.

The signaling protocol used within the control channel can for instance comprise Session Initiation Protocol (SIP), Extensible Messaging and Presence Protocol (XMPP), HTTP, or a proprietary protocol.

The payload of the control channel protocol messages can use any suitable format, examples of which comprise JavaScript Object Notation (JSON) and eXtensible Markup Language (XML). In the remainder of the description, it is for simplicity assumed that HTTP and JSON are used, although it is realized that other formats could alternatively be used.

The present disclosure provides at least the following control channels:
GFP/GCS channel, which is a channel between the GFP 10 and the GCS 20. The GFP/GCS channel may be used for controlling virtual cameras and a graphics engine.
CMx/GCS channel, which is a channel between the virtual camera device 11 and the GCS 20. The CMx/GCS channel may be used for controlling the virtual cameras.
GFP/Viewer channel, which is a channel between the GFP 10, e.g. the director device 12 thereof, and a viewer Vx. The GFP/Viewer channel may be used for controlling local/cloud-based game engines of the viewers. The GFP/Viewer channel is applicable on to those viewers that follow the game from within a game engine.
Viewer/GFP channel, which is a channel between the viewer and the GFP 10, e.g. the director device 12 thereof. The Viewer/GFP channel may be used by viewers for sending feedback to and interact with the GFP 10.

Data that may be included in control channel messages of the control channels exemplified above are given next. In the following, particular examples of data exchanged in the control channel messages are given, but it is noted that yet other data may be exchanged and that the present disclosure is not limited to the below examples.

GFP/GCS channel
Data relating to adding, removing, changing a virtual camera
Data relating to setting virtual cameras' location, direction and/or settings such as focal length, lens, etc.
Data relating to other rendering options, such as for instance video resolution, rendering and encoding frame rate, type: 2D, 3D, high dynamic range (HDR), time of the game (for replay), etc. HDR imaging is a set of techniques used in imaging and photography to reproduce a greater dynamic range of luminosity than possible using standard digital imaging or photographic techniques.
Data relating to other game options, such as which graphic to show, etc. As mentioned earlier, the director may modify a character's facial expressions for a replay to make the situation more dramatic. The director might also censor some violent action if he knows that there are children viewing the event.

An example of a control channel message adding a new virtual camera to the game arena is given below. The example assumes that JSON is used as the format for the payload, that Hypertext Transfer Protocol (HTTP) is used as the control channel protocol, and that the GCS 20 provides a RESTful Application Programming Interface (API) for manipulating the virtual cameras. Representational state transfer (REST) is an abstraction of the World Wide Web (WWW) and a web service may be denoted RESTful if conforming to some constraints, comprising e.g. client-server, stateless, cacheable constraints, all known to a person skilled in the art.

The above-mentioned example of control channel message for adding a new virtual camera:

```
POST /game/cameras HTTP/1.1
Content-Type: application/json;charset=UTF-8
Accept: application/json, text/html
Content-Length: <length>
{
  “camera”: {
    “id”: “John's camera”,
    “position”: {
      “x”: “123”,
      “y”: “1234”,
      “z”: “12”,
    },
    “zoom”: “3”,
    “direction”: “30”,
    “tilt”: “10”,
    “options”: {
      “framerate”: “60”,
      “codec”: “h264”,
      “resolution”: “1080p”,
      “transport”: “RTP”
    }
  }
}
```

The above example adds a virtual camera with the user-specified identifier “John's camera” to specific coordinates (x, y, z) in a three dimensional coordinate space of the game arena. The added virtual camera uses a zoom level 3, is pointing to direction 30 degrees on the horizontal axis and is tilted 10 degrees upwards on the vertical axis. Also some additional options (framerate, codec, resolution) are specified in the example.

GCS/GFP Channel
The GFP 10 may receive media streams, mosaic video stream, special graphical representation, streams from players, etc.
Typically, the GCS 20 sends the video streams of the virtual cameras to the GFP 10 with very high quality (raw or slightly compressed video). However, if network bandwidth between the GFP 10 and GCS 20 is limited, also regularly compressed video can be sent over the Real-time Transport Protocol (RTP).

CMx/GCS Channel

Data exchanged in the messages carried on the control channel between CMx (Cameraman-X) and the GCS 20 can consist of, but are not limited to:
Virtual camera locations, direction and settings (focal length, lens, etc.)
Other rendering options (size, rendering and encoding frame rate, type: 2D, 3D, HDR, etc.)

GFP/Viewer Channel

Data exchanged in the GFP/Viewer control channel messages can consist of, but are not limited to:
A first use case: use GCS 20 to propagate GFP settings: GFP 10 controls the cloud rendering options in GCS, and GCS 20 sends these options to the local game rendering engines (GE).
A second use case: Bypass GCS/Vx and create a direct data channel between GFP 10 and local game engine, i.e. user devices 2.

Viewer/GFP Channel

Data exchanged in the control channel messages can consist of, but are not limited to:
Votes, comments, etc.

In the following some control logic are exemplified.

Adding/Removing a Virtual Camera

For adding and removing virtual cameras, the game engine 21 may provide an API that the GFP 10 can use to add and control virtual cameras within the game arena of a game (see for instance example of FIG. 2 and related text). When the director adds a new camera, the game engine 21 initiates a new video stream and starts sending that to the director. The parameters for the video stream are negotiated over the GFP/GCS control channel.

Selecting a Replay

The GFP 10 sends a replay request for the video stream from a selected virtual camera, at a selected time and speed (can for instance be slow motion). The GFP 10 (e.g. director device 12 or virtual camera device 11 thereof) can specify the camera location beforehand or on the fly, during the replay. The GCS 20 then creates a stream that the GFP 10 can broadcast or provide for broadcasting by e.g. the VSS 30. For this, the GCS 20 needs to store the game states during a certain period of time, for instance the last 30 seconds, and more if possible in view of e.g. available memory, storage and other capacity limits of the GCS 20.

The example below assumes that the GFP/GCS control channel uses JSON over HTTP as the protocol and that the GCS provides a RESTful API towards the GFP. The example shows how a control channel message requesting for a 5-second slow motion replay at speed 0.2× starting from the moment 456 seconds could look like.

```
POST /game/cameras/cam123 HTTP/1.1
Content-Type: application/json;charset=UTF-8
Accept: application/json, text/html
Content-Length: <length>
{
  “action”: “replay”,
  “params”: {
    “starttime”: “456”,
    “duration”: “5”,
    “speed”: “0.2”,
  }
}
```

FIG. 3 is a sequence diagram illustrating various aspects of a gaming event. In particular, FIG. 3 is a sequence diagram illustrating aspects of a providing a gaming event for broadcasting.

The GCS 20, e.g. game engine 21 thereof, may provide (arrow 100) a special graphical representation of virtual cameras in a game world to the GFP 10, e.g. a virtual camera device 11 thereof. The providing of the special graphical representation may have been preceded by a request (not illustrated) from the GFP 10 the GCS 20 for such representation.

The GFP 10 manages (101) the virtual cameras, e.g. using the graphical representation received. Examples of such managing have been given, and comprise e.g. removing virtual cameras, adding virtual cameras, changing settings of virtual cameras etc.

The GFP 10 may determine that a new setting of an existing virtual camera or the addition of a new virtual camera would be required for creating an improved viewer experience of a viewer receiving a broadcasting of a gaming event. The GFP 10, e.g. the virtual camera device 11 thereof, may then for effectuating such desire, transmit (arrow 102) control message comprising relevant virtual camera data to the GCS 20 (e.g. game engine thereof 21).

In response, the GCS 20 renders the requested virtual cameras and starts sending media streams to the GFP 10. In addition, the GFP 10 may receive (arrow 104) media streams from player devices 2.

The GFP 10 processes (arrow 105) the media streams for producing a gaming event film suitable for broadcasting to the viewers.

The produced gaming event film may be provided (arrow 106) to the VSS 30, which broadcasts (arrow 107) the gaming event film to viewer devices 3. It is also conceivable that the GFP 10 handles (arrow 108) the broadcasting for the viewer devices 3.

The GFP 10 may receive (arrow 109) input from the viewers using the viewer devices 3, e.g. voting of gifts to the players.

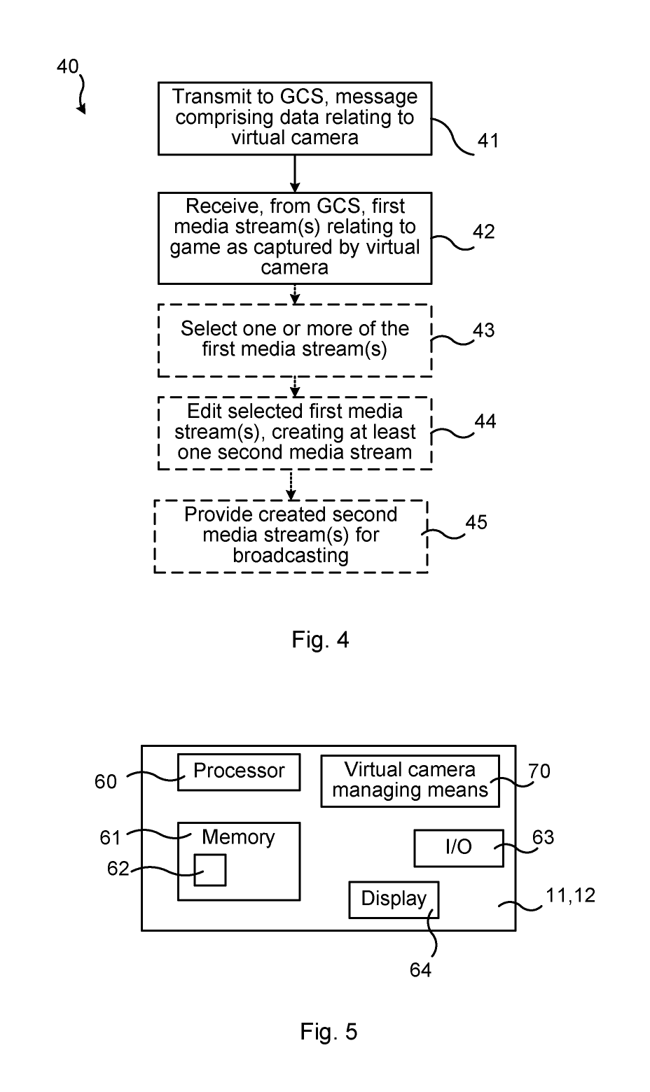

FIG. 4 illustrates a flow chart over steps of a method in a system 10 in accordance with the present disclosure. The features that have been described may be combined in different ways, examples of which are given in the following.

A method 40 is provided which may be performed in a system 10 for handling a media stream relating to an online game provided by a game cloud system 20. The system 10 may for instance comprise the game film production as has been described e.g. in relation to FIG. 1. The system 10 comprising at least one node 11, 12, e.g. one or more virtual camera devices CM1, CM2, . . . , CMM and/or one or more director devices 12.

The method 40 comprises transmitting 41, to the game cloud system 20, a message comprising data relating to at least one virtual camera.

The method 40 comprises receiving 42, from the game cloud system 20, at least one first media stream relating to the online game as captured by the at least one virtual camera.

According to the method 40, a user wanting to produce a film related to an online game may use a virtual camera device CM1, CM2, . . . , CMM for transmitting a message comprising data relating to a virtual camera, the message data defining a new virtual camera. The user may then receive, in response, a media stream relating to the game as captured by the virtual camera that was defined by the message.

In one embodiment, the system 10 comprises a virtual camera device CM1, CM2, . . . , CMM. In other embodiments, the system 10 comprises one or more virtual camera device CM1, CM2, . . . , CMM and one or more director devices 12.

The method 40 enables improvements on the viewer's experience and makes game broadcasts easier to follow owing to the possibility to select, for instance by a director or film maker choosing the viewing directions and locations by sending data relating to a virtual camera.

In an embodiment, the method 40 comprises:
selecting 43 one or more of the at least one first media streams, and
editing 44 the selected one or more of the at least one first media streams, creating at least one second media stream.

A system 10 implementing this embodiment, may comprise a virtual camera device 11 and a director device 12, wherein the steps of transmitting 41 and receiving 42 are performed in the virtual camera device 11 and the selecting 43 and editing 44 is performed in the director device 12. The director device 12 may receive all first media streams from the virtual camera device 11 and then select 43 one or more of the first media streams, upon which editing 44 is performed. Such editing 44 may be automated by configuring the director device 12 to handle the first media streams in a certain way, for instance based on viewers' input such as votes and/or by adding graphics to highlight an object shown in the media streams, to mention a few examples. In other embodiments, such editing 44 comprises receiving, in the director device 12, input from a user (a director) and performing the editing based on the input. For instance, the user may input a set of instructions for modifying graphics, adding an event etc. In another embodiment, the director device 12 and the virtual camera device 11 is an integrated unit.

The gaming events are rendered more engaging by means of the method, by providing means to add interactive features, replays, slow motion, etc. Further still, the method 40 provides a producer of a game film, e.g. to be broadcast, with means to control virtual cameras, to add events, to modify graphics, etc. Instead of the viewers only seeing what each individual player is doing, or looking at, as in prior art, the present disclosure enables the provision of a better view, a replay/slow motion with different camera angles etc. in order to understand the whole game progress and thus improving on the viewer experience.

In various embodiments, the editing 44 comprises one or more of: modifying graphics, adding an event, adding a slow motion replay of an event, adding a replay of an event as captured from a selected virtual camera at a selected time and speed, mixing, switching, adding a video stream relating to a player of the online game, censoring parts of the at least one first media stream. As noted above, such editing actions may be effectuated based on user input or be automated by certain actions being programmed into the director device 12.

In a variation of the above embodiment, the method 40 comprises providing 45 the created at least one second media stream for broadcasting. The system 10, e.g. the director device 12, may provide the one or more first media streams relating to the online game as captured by the at least one virtual camera, and/or the created at least one second media streams, to the video streaming service 30. The video streaming service 30 may broadcast the received media streams in any known manner.

In various embodiments, the method 40 comprises requesting, from the game cloud system 20, one or more additional virtual cameras and receiving corresponding first media streams, and/or requesting changes to an existing virtual camera.

In various embodiments, the method 40 comprises receiving, from the game cloud system 20, a graphical representation 25 of configured virtual cameras.

In a variation of the above embodiment, the method 40 comprises providing the graphical representation 25 as an interface for receiving input from a user. This embodiment may for instance be implemented as illustrated in and described with reference to FIG. 2.

In various embodiments, the at least one first media stream comprises at least one virtual camera signal capturing events of the online game.

In various embodiments, the data relating to the at least one virtual camera comprises one or more of: adding of a virtual camera, deleting of a virtual camera, change of settings of a virtual camera, setting of location of a virtual camera within the online game, setting of a direction of a virtual camera within the online game, setting the time and replay speed of the requested event, settings of a virtual camera, focal length, type of lens, size of frames of the first media stream, selecting graphical components to be or not to be rendered by the game cloud system 20, rendering frame rate, encoding frame rate, type of rendering comprising two-dimensional, three-dimensional or high dynamic range.

FIG. 5 illustrates schematically a system 10 and in particular means 11, 12 for implementing embodiments of the present disclosure. The system 10, e.g. the GFC as described earlier, comprises at least one node 11, 12, e.g. the virtual camera device 11 and/or the director device 12. As mentioned earlier, the system 10 may comprise yet additional nodes, and it is also noted that the functions may be integrated into a single node. In the following, features of the system 10 are described and illustrated by a single node, but it is understood that the various features and functions provided by the system 10 may be distributed on different nodes 11, 12 of the system 10.

The node 11, 12 comprises at least one processor 60 comprising any combination of one or more of a central processing unit (CPU), multiprocessor, microcontroller, digital signal processor (DSP), application specific integrated circuit etc. capable of executing software instructions stored in a memory 61, which can thus be a computer program product 61. The processor 60 can be configured to execute any of the various embodiments of the method for instance as described in relation to FIG. 4.

The node 11, 12 comprises one or more input/output means 63 (denoted In/Out in the FIG. 5). When the system 10 comprises several nodes, such as one virtual camera device 11 and one director device 12, then both nodes comprises means for mutual communication. Such means may for instance comprise interfaces, protocols, cables etc. The node 11, 12 may also comprise an interface for communication with a game engine 21 of a game cloud system 20. The input means may additionally comprise means for receiving input from a user, e.g. in the form of keyboard, a mouse, touchpad, track point etc.

The node 11, 12 may further comprise a display 64, which display 64 may comprise a graphical user interface. The display may also be a user input means for instance a touch-screen. On the display 64 a user interface such as the one described e.g. with reference to FIG. 2 may be shown.

The node 11, 12 may further comprise virtual camera managing means 70, which may for instance comprise means for providing a message comprising data relating to a virtual camera to be rendered or to be removed or to be altered in some way. The virtual camera managing means 70 may further comprise means, e.g. processing circuitry, for editing received media streams, in ways that have been described earlier.

The memory 61 can for instance be any combination of random access memory (RAM) and read only memory (ROM), Flash memory, magnetic tape, Compact Disc (CD)-ROM, digital versatile disc (DVD), Blu-ray disc etc. The memory 61 may also comprise persistent storage, which, for example, can be any single one or combination of magnetic memory, optical memory, solid state memory or even remotely mounted memory.

A data memory (not illustrated) may also be provided for reading and/or storing data during execution of software instructions in the processor 60. Such data memory can be any combination of random access memory (RAM) and read only memory (ROM).

The system 10 may be implemented as a single node or several nodes, and the system 10 may be implemented using function modules and/or software instructions such as computer program executing in a processor and/or using hardware such as application specific integrated circuits, field programmable gate arrays, discrete logical components etc.

A system 10 is provided for handling a media stream relating to an online game provided by a game cloud system 20, the system 10 comprising at least one node 11, 12. The system 10 is configured to:
transmit, to the game cloud system 20, a message comprising data relating to at least one virtual camera, and
receive, from the game cloud system 20, at least one first media stream relating to the online game as captured by the at least one virtual camera.

The system 10 is configured to perform the method 40 as described in various embodiments with reference to FIG. 4, for instance by comprising one or more processors and memory, wherein the memory contains instructions executable by the processor, whereby the system 10 is operative to perform the method.

In an embodiment, the system 10 is configured for selecting one or more of the at least one first media streams and editing the selected one or more of the at least one first media streams, creating at least one second media stream.

In variations of the above embodiment, the system 10 is configured for editing by performing one or more of: modifying graphics, adding an event, adding a slow motion replay of an event, adding a replay of an event as captured from a selected virtual camera at a selected time and speed, mixing, switching, adding a video stream relating to a player of the online game, censoring parts of the at least one first media stream.

In an embodiment, the system 10 is configured provide the created at least one second media stream for broadcasting.

In an embodiment, the system 10 is configured request, from the game cloud system 20, one or more additional virtual cameras and to receive corresponding first media streams, and/or requesting changes to an existing virtual camera.

In an embodiment, the system 10 is configured receive, from the game cloud system 20, a graphical representation 25 of configured virtual cameras.

In a variation of the above embodiment, the system 10 is configured to provide the graphical representation 25 as an interface for receiving input from a user.

In an embodiment, at least one first media stream comprises at least one virtual camera signal capturing events of the online game.

In various embodiments, the data relating to the at least one virtual camera comprises one or more of: adding of a virtual camera, deleting of a virtual camera, change of settings of a virtual camera, setting of location of a virtual camera within the online game, setting of a direction of a virtual camera within the online game, setting the time and replay speed of the requested event, settings of a virtual camera, focal length, type of lens, size of frames of the first media stream, selecting graphical components to be or not to be rendered by the game cloud system 20, rendering frame rate, encoding frame rate, type of rendering comprising two-dimensional, three-dimensional or high dynamic range.

The present disclosure also encompasses a computer program 62 for implementing the methods as described above. The computer program 62 may be used in at least one node 11, 12 of a system 10 for handling a media stream relating to an online game provided by a game cloud system 20, the computer program 62 comprising computer program code, which, when executed on at least one processor 60 on the at least one node 11, 12 causes the node 11, 12 to perform the method 40 as described e.g. in relation to FIG. 4.

The present disclosure also encompasses a computer program product 61 comprising a computer program 62 as above and a computer readable means on which the computer program 62 is stored.

The present disclosure provides, in an aspect, a system 10 (comprising one or several nodes) for handling a media stream relating to an online game provided by a game cloud system 20. The system 10 comprises at least one node 11, 12, comprising a first means for transmitting, to the game cloud system 20, a message comprising data relating to at least one virtual camera. Such first means may be implemented for instance by the virtual camera managing means 70 and/or an interface means (e.g. input/output means 63) towards the game cloud system 20. Such first means may comprise various processing circuitry, e.g. processing circuitry for transmitting a message.

The system 10 comprises second means for receiving, from the game cloud system 20, at least one first media stream relating to the online game as captured by the at least one virtual camera. Such second means may be implemented by an interface means (e.g. input/output means 63) and/or by processing circuitry for receiving at least one such first media stream.

The system 10 may further comprise third means for selecting one or more of the at least one first media streams. Such third means may for instance be implemented by processing circuitry adapted for selection, e.g. the virtual camera managing means 70. Such third means may in other instances comprise processing circuitry adapted for reception and handling of a user input, wherein the user input relates to the selection of a particular first media stream.

The system 10 may further comprise fourth means for editing the selected one or more of the at least one first media streams, creating at least one second media stream. Such fourth means may for instance be implemented by processing circuitry adapted for editing, e.g. virtual camera managing means 70.

The system 10 may comprise still additional means for implementing the various embodiments of the present disclosure.

The present disclosure, as described, provides for instance new control channels and architecture, which enable professional production of live game streaming events. The virtual cameras made possible by and provided by the present disclosure allow the film director to see where he wants, to film how he wants, and thus create his own show, focusing on different parts of the game, and changing the rendering settings. The present disclosure also enables additional features such as replays, slow motion, manipulation of game graphics, and viewer interaction. The introducing and use of the control channels as described allow someone to implement these new features.

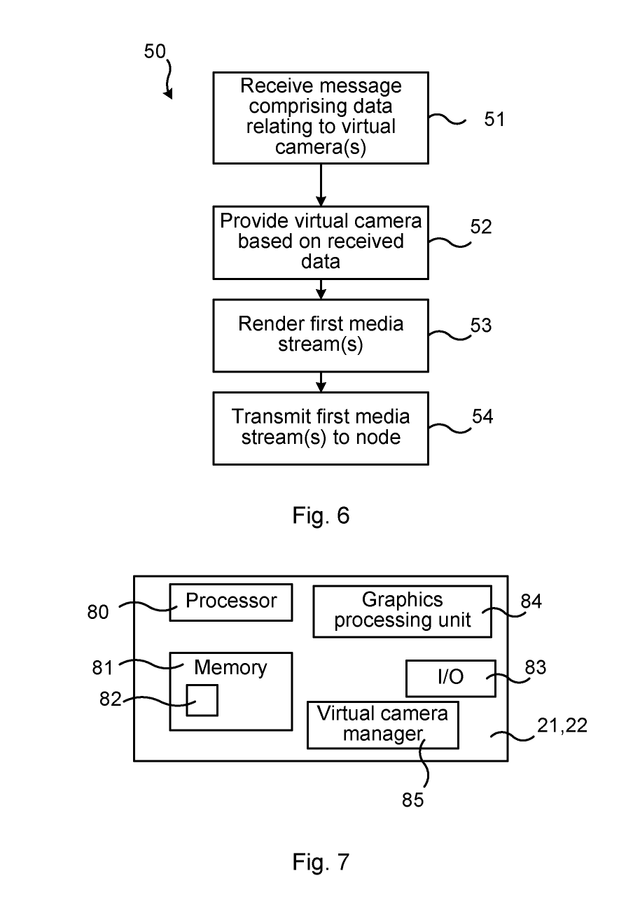

FIG. 6 is a flow chart over steps of a method in a game engine 21 in accordance with the present disclosure. The features that have been described may be combined in different ways, examples of which are given in the following.

The method 50 may be performed in a game engine 21 for providing a media stream relating to an online game. The method 50 comprises receiving 51, from a node 11, 12, a message comprising data relating to at least one virtual camera.

The method 50 comprises providing 52 at least one virtual camera based on the received data.

The method 50 comprises rendering 53 at least one first media stream relating to the online game as captured by the at least one virtual camera.

The method 50 comprises transmitting 54 the at least one first media stream to the node 11, 12.

In an embodiment, the method 50 comprises providing a graphical representation 25 of configured virtual cameras to the node 11, 12.

FIG. 7 illustrates schematically a game engine 21, 22 for implementing embodiments of the present disclosure. The game engine 21, 22 may for instance comprise a server or other processing device. A game engine 21 is thus provided for providing a media stream relating to an online game. The game engine 21 is configured to:
receive, from a node 11, 12, a message comprising data relating to at least one virtual camera,
provide at least one virtual camera based on the received data,
render at least one first media stream relating to the online game as captured by the at least one virtual camera, and
transmit the at least one first media stream to the node 11, 12.

The game engine 21 is configured to perform the method 50 as described in various embodiments with reference to FIG. 6, e.g. by comprising one or more processors and memory, wherein the memory contains instructions executable by the processor, whereby the game engine 21 is operative to perform the method.

In an embodiment, the game engine 21 is configured to provide a graphical representation 25 of configured virtual cameras to the node 11, 12.

The game engine 21 comprises at least one processor 80 comprising any combination of one or more of a central processing unit (CPU), multiprocessor, microcontroller, digital signal processor (DSP), application specific integrated circuit etc. capable of executing software instructions stored in a memory 81, which can thus be a computer program product 81. The processor 80 can be configured to execute any of the various embodiments of the method for instance as described in relation to FIG. 6.

The memory 81 can for instance be any combination of random access memory (RAM) and read only memory (ROM), Flash memory, magnetic tape, Compact Disc (CD)-ROM, digital versatile disc (DVD), Blu-ray disc etc. The memory 61 may also comprises persistent storage, which, for example, can be any single one or combination of magnetic memory, optical memory, solid state memory or even remotely mounted memory.

A data memory (not illustrated) may also be provided for reading and/or storing data during execution of software instructions in the processor 80. Such data memory can be any combination of random access memory (RAM) and read only memory (ROM).

The game engine 21 comprises one or more input/output means 83 (denoted In/Out in the FIG. 7). Such means may for instance comprise interfaces, protocols, cables etc. The game engine 21 may also comprise an interface for communication with one or more nodes 11, 12 of a game cloud system 20. The input means may additionally comprise means for receiving input from a user, e.g. in the form of keyboard, a mouse, touchpad, track point etc.

The game engine 21 may further comprise a virtual camera manager 85, which may for instance comprise means, e.g. processing circuitry, for rendering a virtual camera according to received data, and/or removing an existing virtual camera, or altering settings of a virtual camera according to received data.

The game engine 21 may further comprise a graphics processing unit (GPU) 84, also denoted graphics engine, for rendering. That is, for the process of generating an image from a 2D or 3D model, or models in a so called scene file, by means of computer programs. The results of such a model may also be called a rendering. A scene is rendered using animation parameters and description of the current environment sent by a real-time application and camera specification. The camera specification is produced based on a description of current events plus the existing state of the animation. The functions and implementation of the GPU 84 are known as such and will not be described in more detail.

The game engine 21 may comprise still additional means for providing the game to players, which means are known as such and will not be described herein.

The present disclosure also encompasses a computer program 82 for implementing the methods as described above. The computer program 82 may be used in the game engine 21 for providing a media stream relating to an online game. The computer program 82 comprises computer program code, which, when executed on at least one processor 80 of the game engine 21 causes the game engine 21 to perform the method 50 as described e.g. in relation to FIG. 6.

The present disclosure also encompasses a computer program product 81 comprising a computer program 82 as above and a computer readable means on which the computer program 82 is stored.

The present disclosure provides, in an aspect, a game engine 21 for providing a media stream relating to an online game. The game engine 21 comprise first means for receiving, from a node 11, 12, a message comprising data relating to at least one virtual camera. Such first means may be implemented for instance by an interface means (e.g. input/output means 83). Such first means may comprise various processing circuitry, e.g. processing circuitry for reception.

The game engine 21 may comprise second means for providing at least one virtual camera based on the received data. Such second means may for instance comprise a virtual camera manager 85, e.g. comprising processing circuitry adapted to provide such virtual camera based on received data, by using program code stored in a memory.

The game engine 21 may comprise third means for rendering at least one first media stream relating to the online game as captured by the at least one virtual camera. Such third means may be implemented for instance by the graphics processing unit 84 and/or a virtual camera manager 85 and or processing circuitry adapted to perform such rendering by using program code stored in a memory.

The game engine 21 may comprise fourth means for transmitting the at least one first media stream to the node 11, 12. Such fourth means may comprise for instance be implemented by an interface means (e.g. input/output means 83) and/or processing circuitry for transmitting such media streams.

The game engine 21 may comprise fifth means for providing a graphical representation 25 of configured virtual cameras to the node 11, 12. Such fifth means may again comprise a virtual camera manager 85, e.g. comprising processing circuitry adapted to provide such graphical representation by using program code stored in a memory and/or input/output means 83 for communicating with the node 11, 12.

The game engine 21 may comprise still additional means for implementing the various embodiments of the present disclosure.

The invention has mainly been described herein with reference to a few embodiments. However, as is appreciated by a person skilled in the art, other embodiments than the particular ones disclosed herein are equally possible within the scope of the invention, as defined by the appended patent claims.

1. A method performed in a system for handling a media stream relating to an online game provided by a game cloud system, the system comprising at least one node, the method comprising:
transmitting, to the game cloud system, a message comprising data relating to at least one virtual camera; and
receiving, from the game cloud system, at least one first media stream relating to the online game as captured by the at least one virtual camera.

2. The method of claim 1, further comprising:
selecting one or more of the at least one first media streams, and
editing the selected one or more of the at least one first media streams, creating at least one second media stream.

3. The method of claim 2, wherein the editing comprises one or more of: modifying graphics, adding an event, adding a slow motion replay of an event, adding a replay of an event as captured from a selected virtual camera at a selected time and speed, mixing, switching, adding a video stream relating to a player of the online game, censoring parts of the at least one first media stream.

4. The method of claim 2, further comprising:
providing the created at least one second media stream for broadcasting.

5. The method of claim 1, further comprising requesting, from the game cloud system, one or more additional virtual cameras and receiving corresponding first media streams, and/or requesting changes to an existing virtual camera.

6. The method of claim 1, further comprising receiving, from the game cloud system, a graphical representation of configured virtual cameras.

7. The method of claim 6, further comprising providing the graphical representation as an interface for receiving input from a user.

8. The method of claim 1, wherein the at least one first media stream comprises at least one virtual camera signal capturing events of the online game.

9. The method of claim 1, wherein the data relating to the at least one virtual camera comprises one or more of: adding of a virtual camera, deleting of a virtual camera, change of settings of a virtual camera, setting of location of a virtual camera within the online game, setting of a direction of a virtual camera within the online game, setting the time and replay speed of the requested event, settings of a virtual camera, focal length, type of lens, size of frames of the first media stream, selecting graphical components to be or not to be rendered by the game cloud system, rendering frame rate, encoding frame rate, type of rendering comprising two-dimensional, three-dimensional or high dynamic range.

10. A system for handling a media stream relating to an online game provided by a game cloud system, the system comprising at least one node and being configured to:
transmit, to the game cloud system, a message comprising data relating to at least one virtual camera; and
receive, from the game cloud system, at least one first media stream relating to the online game as captured by the at least one virtual camera.

11. The system of claim 10, further configured for selecting one or more of the at least one first media streams and editing the selected one or more of the at least one first media streams, creating at least one second media stream.

12. The system of claim 11, wherein the system is configured for editing by performing one or more of: modifying graphics, adding an event, adding a slow motion replay of an event, adding a replay of an event as captured from a selected virtual camera at a selected time and speed, mixing, switching, adding a video stream relating to a player of the online game, censoring parts of the at least one first media stream.

13. The system of claim 12, further configured to provide the created at least one second media stream for broadcasting.

14. The system of claim 10, further configured to request, from the game cloud system, one or more additional virtual cameras and to receive corresponding first media streams, and/or requesting changes to an existing virtual camera.

15. The system of claim 10, further configured to receive, from the game cloud system, a graphical representation of configured virtual cameras.

16. The system of claim 15, further configured to provide the graphical representation as an interface for receiving input from a user.

17. The system of claim 10, wherein the at least one first media stream comprises at least one virtual camera signal capturing events of the online game.

18. The system of claim 10, wherein the data relating to the at least one virtual camera comprises one or more of: adding of a virtual camera, deleting of a virtual camera, change of settings of a virtual camera, setting of location of a virtual camera within the online game, setting of a direction of a virtual camera within the online game, setting the time and replay speed of the requested event, settings of a virtual camera, focal length, type of lens, size of frames of the first media stream, selecting graphical components to be or not to be rendered by the game cloud system, rendering frame rate, encoding frame rate, type of rendering comprising two-dimensional, three-dimensional or high dynamic range.

19. A computer program product comprising a non-transitory computer readable medium storing a computer program for a system comprising at least one node for handling a media stream relating to an online game provided by a game cloud system, the computer program comprising computer program code, which, when executed on at least one processor of the system causes the system to perform the method of claim 1.

20. (canceled)

21. A method performed in a game engine for providing a media stream relating to an online game, the method comprising:
receiving, from a node, a message comprising data relating to at least one virtual camera;
providing at least one virtual camera based on the received data;
rendering at least one first media stream relating to the online game as captured by the at least one virtual camera; and
transmitting the at least one first media stream to the node.

22. The method of claim 21, further comprising providing a graphical representation of configured virtual cameras to the node.

23. A game engine for providing a media stream relating to an online game, the game engine being configured to:
receive, from a node, a message comprising data relating to at least one virtual camera;
provide at least one virtual camera based on the received data;
render at least one first media stream relating to the online game as captured by the at least one virtual camera; and
transmit the at least one first media stream to the node.

24. The game engine of claim 23, configured to provide a graphical representation of configured virtual cameras to the node.

25. A computer program product comprising a non-transitory computer readable medium storing a computer program for a game engine for providing a media stream relating to an online game, the computer program comprising computer program code, which, when executed on at least one processor on the game engine causes game engine to perform the method of claim 21.

26. (canceled)
